(19) United States
(12) Patent Application Publication
(10) Pub. No.: US 2007/0259144 A1
(43) Pub. Date: Nov. 8, 2007

(54) Silver/plastic combination that binds hazardous agents and provides anti-microbial protection

(76) Inventor: Roy J. Mankovitz, Santa Barbara, CA (US)

Correspondence Address: SANDRA LEE LIPKIN;A LAW CORPORATION, 1891 GOODYEAR AVE., SUITE 622, VENTURA, CA, 93003, US

(21) Appl. No.: 11/796,113

(22) Filed: Apr. 25, 2007

Related U.S. Application Data
(60) Provisional application No. 60/798,077, filed on May 5, 2006.

(51) Int. Cl. B32B 27/08

(52) U.S. Cl. 428/35.7

(57) ABSTRACT

A plastic water bottle that is molded with ionic silver therein that acts as a binding agent for hazardous leaching elements found in the plastic, such as bisphenol-A, and that also imparts anti-microbial properties, well known to exist with colloidal ionic silver, to the water stored in the bottle as well as the person holding the bottle.

### REFERENCE TO PRIOR APPLICATION

This application claims the priority of provisional application 60/798,077, filed May 5, 2006 entitled SILVER/PLASTIC MOLDING COMBINATION THAT BINDS HAZARDOUS AGENTS AND PROVIDES ANTI-MICROBIAL PROTECTION by Roy J. Mankovitz.

### BACKGROUND OF THE INVENTION

1. Field of the Invention

The present invention relates generally to the field of plastic water bottles, and in particular to a plastic water bottle that eliminates hazardous chemical leaching while adding anti-microbial properties.

2. Description of the Prior Art

For centuries, silver has been known to impart anti-microbial properties to persons who consume it in its proper form, i.e., it its colloidal ionic form. Studies on the effectiveness of silver as an anti-microbial have shown that silver in its ionic form, rather than its particulate form, has the ability to inhibit the growth of staph, E. coli. and other bacteria. It has been shown to act as an anti-biotic as well as a tissue regenerator. The use of colloidal ionic silver has demonstrated its analgesic and anti-inflammatory effects as well.

Silver ions made into a hydrosol, i.e., a liquid that contains the positively charged silver cations without the presence of negatively charged anions, has been shown to be as gentle as water on the consumer. Research in this area has shown that this silver ion activity is oligodynamic, i.e., it is active in very small quantities. Because it is effective in small quantities, the possible side effect of argyria wherein a patient develops blue skin after exposure to high quantities of silver, becomes remote to non-existent. Additionally, because it is effective in small quantities, it is relatively inexpensive to administer.

It is noteworthy that colloidal ionic silver offered as a dietary supplement to boost the immune system is typically offered in glass containers. The reason given for this is that the silver tends to leach chemicals from plastics. It is this phenomenon, combined with the anti-microbial properties of colloidal ionic silver the instant invention seeks to exploit.

Plastic water bottles have become de rigeur in contemporary society. For convenience and healthy hydration, it is commonplace for people to use plastic water bottles to carry water with them wherever they are to keep themselves hydrated. Plastic is cheap and lightweight and is generally preferred over glass or stainless steel as a means for transporting small amounts of drinking water.

A particularly popular plastic used for drinking water is polycarbonate, particularly because of its hardiness. There is a major downside to the use of polycarbonate, however. Polycarbonate is made of the bisphenol-A monomer, which is a hazardous chemical that leaches into water stored in a polycarbonate water bottle.

Bisphenol-A can be leached into a water bottle contents through normal wear and tear, exposure to heat and cleaning agents. This includes leaving your plastic water bottle in your car during errands, in your back pack during hikes and running it through your dishwasher and using harsh detergents. Detectable levels of bisphenol-A have been found to have leached into liquids at room temperature. Just having your plastic water bottle sitting on your desk can be potentially harmful.

Bisphenol-A can activate estrogen receptors leading to similar physiological effects as the body's own estrogens. Bisphenol-A can impair the reproductive organs and have adverse effects on tumors, breast tissue development and prostate development by reducing sperm count.

Prior art in the field has sought to protect plastic with silver, particularly as an anti-microbial agent. None, however, have sought to bind up hazardous leaching agents, such as bisphenol-A. Westlake Plastic Technologies (www.wptech.com) has developed a plastic resin that incorporates silver into the plastic to create plastic products at risk of bacteria and other microbial contamination, such as food processing and restaurant equipment, cutting boards, countertops, food packaging, ice machine components and bulk food containers.

A silver zeolite has been developed by AGION® Technologies, Inc. The AGION® compound is a combination of silver and zeolite. The zeolite is utilized as a container for the silver so that it does not combine with other substances. U.S. Pat. App. 20050058682 to Sharratt describes using the silver zeolite product as a coating for surgical instruments.

It is the intent of the instant invention not that the silver be manufactured to avoid interference with other substances. Rather, it is desired that the silver interact with the bisphenol-A, binding it and removing it as a potential hazard to the person drinking out of the polycarbonate water bottle. Silver ions not consumed through binding with the bisphenol-A would remain in the plastic, adding anti-microbial properties both to the water contained in the bottle as well as the skin of the person holding the bottle.

### SUMMARY OF THE INVENTION

The present invention seeks to remove hazardous leaching chemicals from water bottles made of polycarbonate, in particular, bisphenol-A. This is achieved through the addition of colloidal ionic silver to the plastic at the time it is molded to form a drinking water bottle.

It is the primary object of the invention to prevent the leaching of hazardous chemicals, such as bisphenol-A, into the water contained in water bottles made of polycarbonate through the addition of colloidal ionic silver as a binding agent.

It is yet another object of the invention to provide anti-microbial properties to the water contained in a water bottle made of polycarbonate through the use of colloidal ionic silver added to the polycarbonate plastic during molding.

It is yet another object of the invention to provide anti-microbial protection to the user of the silver ion infused water bottle through the transfer of silver to the skin of the user.

The preferred embodiment of the instant invention provides for a container for liquids comprising an internal chamber for housing the liquids; an external shell defining the shape of the internal chamber wherein the external shell contains a quantity of colloidal silver sufficient to provide anti-bacterial, anti-fungal and anti-microbial properties to the external shell and any matter that comes into contact therewith.

The above embodiment can be further modified by defining that the external shell is made of a moldable synthetic plastic.

The above embodiment can be further modified by defining that the external shell is made of polycarbonate.

The above embodiment can be further modified by defining that a means is provided for adding liquids to the container and removal of the liquids therefrom, such as an opening in the top of the container that is sealable with a cap.

The above embodiment can be further modified by defining that a means is provided for adding liquids to the container and removal of the liquids therefrom, such as a spigot located near the bottom of said container.

An alternative embodiment of the present invention is a method of manufacturing a container for liquids that provides anti-bacterial, anti-fungal and anti-microbial properties comprising molding of an exterior shell with a quantity of colloidal silver sufficient to provide said anti-bacterial, anti-fungal and anti-microbial properties to infuse said shell with said colloidal silver; shaping of the exterior shell into a desired to shape that defines an interior chamber for the housing of liquids; placement of liquids into the interior chamber; sealing the liquids in the interior chamber.

The above embodiment can be further modified by defining that the external shell is made of a moldable synthetic plastic.

The above embodiment can be further modified by defining that the external shell is made of polycarbonate.

The above embodiment can be further modified by defining that a means is provided for adding liquids to the container and removal of the liquids therefrom, such as an opening in the top of the container that is sealable with a cap.

The above embodiment can be further modified by defining that a means is provided for adding liquids to the container and removal of the liquids therefrom, such as a spigot located near the bottom of said container.

### DETAILED DESCRIPTION OF A PREFERRED EMBODIMENT

The preferred embodiment of the invention is illustrated in the attached figures.

Plastic made to form water bottles, such as polycarbonate, is molded to include a colloidal ionic silver that will bind up hazardous leaching chemicals found in polycarbonates, such as bisphenol-A, and keep them out of the drinking water found therein. Besides absorbing the hazardous leaching elements from the polycarbonate the well-known anti-microbial properties of ionic colloidal silver will be present in the water contained in the bottle. Additionally, the anti-microbial properties and immune-boosting activity of the colloidal ionic silver will be transferred through dermal exposure to the person holding a water bottle, since the bottle is made of plastic molded with colloidal ionic silver.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. A container for liquids comprising
an internal chamber for housing said liquids;
an external shell defining the shape of said internal chamber;
wherein said external shell contains a plastic and quantity of silver infused with said plastic and sufficient to provide anti-bacterial, anti-fungal and anti-microbial properties to said external shell and any matter that comes into contact therewith and to bind with the plastic to reduce the leaching of chemicals from the plastic into the liquid.

2. A container as defined in claim 1 wherein said external shell is made of a moldable synthetic plastic.

3. A container as defined in claim 2 wherein said external shell is made of polycarbonate.

4. A container as defined in claim 1 wherein a means is provided for adding liquids to said container and removal of said liquids therefrom, such as an opening in the top of the container that is sealable with a cap.

5. A container as defined in claim 1 wherein the silver is in the form of a colloid.

6. A method of manufacturing a container for holding a liquid comprising;
forming an exterior shell of plastic; and including a quantity of silver infused with said plastic sufficient to provide anti-bacterial, anti-fungal and anti-microbial properties and to bind with the plastic to reduce the leaching of chemicals from the plastic into the liquid.

7. A method as defined in claim 6 wherein said external shell is made of a moldable synthetic plastic.

8. A method as defined in claim 7 wherein said external shell is made of polycarbonate.

9. A method as defined in claim 6 including means provided for adding liquids to said container and removal of said liquids therefrom.

10. A method as defined in claim 6 wherein the silver is in the form of a colloid.
